(19) United States
(12) Patent Application Publication
(10) Pub. No.: US 2012/0174876 A1
(43) Pub. Date: Jul. 12, 2012

(54) BODY ARMOR

(75) Inventor: Allen R. Johnson, Grand Rapids, MI (US)

(73) Assignee: MAGNUM SAFETY PRODUCTS, LLC, Grand Rapids, MI (US)

(21) Appl. No.: 12/535,881

(22) Filed: Aug. 5, 2009

Related U.S. Application Data
(60) Provisional application No. 61/086,388, filed on Aug. 5, 2008.

(51) Int. Cl. F41H 1/02; A01K 13/00

(52) U.S. Cl. 119/850

(57) ABSTRACT

A ballistic garment for use while hunting small game includes a reduced-layer ballistic panel. The ballistic panel generally includes substantially fewer layers of ballistic fabric material than are commonly used in bulletproof vests and the like, in order to provide comfort and preserve range of motion of the wearer while providing protection against shot pellets commonly discharged from shotguns and other firearms used while hunting small game. The body armor may be adapted for use by a human wearer, or may be configured for use by a canine such as a hunting dog. The ballistic panel may be removable from the garment and may include a waterproof or water-resistant outer layer for protecting the ballistic fabric layers from moisture.

### CROSS REFERENCE TO RELATED APPLICATION

The present application claims the benefit of U.S. provisional application Ser. No. 61/086,388, filed Aug. 5, 2008, which is hereby incorporated herein by reference in its entirety.

### FIELD OF THE INVENTION

The present invention relates to body armor for protection against projectiles and/or impalement.

### BACKGROUND OF THE INVENTION

Small game hunters, such as bird hunters, typically use shotguns loaded with cartridges containing bird shot, which may be in the form of lead or steel pellets or the like. Because small game hunters typically hunt with fellow hunters and/or with hunting dogs, such as bird dogs, there is a risk that a hunter or hunting dog will be accidentally shot with pellets, potentially causing serious injury or death.

### SUMMARY OF THE INVENTION

The present invention provides a ballistic garment for facilitating safe hunting of small game, such as birds and small rodents. The garment includes a ballistic panel made of substantially fewer layers of ballistic fabric than is commonly used in a so-called “bulletproof vest,” which may typically have approximately twenty-one layers of ballistic fabric. The ballistic panel of the present invention is thus generally lighter in weight and more flexible than bulletproof vests, and is capable of resisting or stopping lead shot pellets, and may be capable of resisting or stopping steel shot pellets, such as is commonly used for hunting small game, such as birds and small rodents, including quail, pheasants, squirrels, rabbits, and the like. Optionally, the ballistic garment may be fitted to a hunting dog or the like to protect the dog while hunting.

According to one form of the present invention, the ballistic garment includes a flexible ballistic panel made of a plurality of layers of ballistic fabric material. The layers of ballistic fabric material may have a combined weight of between about 0.04 pounds per square foot and about 0.9 ounces per square foot. The ballistic panel is configured to prevent shot pellets fired from a shot gun or other firearm from completely penetrating the panel. The ballistic garment is thus substantially lighter and more flexible than bulletproof vests, while providing adequate protection against bird shot and the like, which is typically used while hunting small game.

According to one aspect, the panel is made up of between four and eight layers of ballistic fabric materials. Optionally, the ballistic fabric materials include single aramid fabric, laminated aramid fabric, high tenacity nylon, and/or polypropylene.

According to another aspect, the ballistic garment may be sized and shaped to fit a human wearer or, optionally, may be sized and shaped to fit a canine wearer.

Optionally, such as when the ballistic garment is configured to fit a canine wearer, the garment includes a non-ballistic fabric material attached to a portion of a perimeter region of the ballistic panel. The non-ballistic fabric material may be a breathable mesh material, and may be water-resistant and resistant to being snagged by burrs and other plant materials.

Optionally, such as when the ballistic garment is configured to fit a canine wearer, the garment includes a stab or impalement or puncture-resistant fabric material attached to a portion of a perimeter region of the ballistic panel. The stab or impalement or puncture-resistant fabric material may be a woven ballistic material, and may be water-resistant and resistant to being snagged by burrs and other plant materials.

Optionally, the garment may include non-ballistic inserts or attachments, such as floatation devices or cooling packs, handles, or coupling members, which may be used to assist or provide comfort for the wearer.

Optionally, the ballistic panel may be incorporated into an outer fabric shell that defines an interior region for receiving the ballistic panel. The ballistic panel may be removably installed in the interior region of the fabric shell, and may include fasteners, such as hook-and-loop fasteners, buttons, snaps, or the like, in order to hold the ballistic panel in position within the fabric outer shell.

According to another form of the present invention, a method of hunting is provided. The method includes providing a firearm loaded with at least one cartridge, the cartridge comprising a plurality of shot pellets and having a limited range. A ballistic garment is also provided, the ballistic garment having a flexible ballistic panel capable of substantially preventing the shot pellets from completely penetrating the panel when the shot pellets are discharged from the firearm toward the panel. The ballistic garment is positioned on a wearer, and hunting with the firearm is commenced while the wearer of the ballistic garment is within the limited range of the firearm. Optionally, the wearer of the ballistic garment may be a human wearer or a canine wearer.

Therefore, a ballistic garment is provided that is relatively flexible, lightweight, and comfortable for a wearer, such as a human or a canine, and which is capable of stopping bird shot or the like, such as during hunting activities. The ballistic garment includes a ballistic panel having substantially fewer layers than is commonly used for a bulletproof vest, such as a twenty-one layer vest. The ballistic panels may be fitted into a vest for a human wearer, or may be sewn or fitted to a form-fitting jacket adapted to fit and closely emulate a canine wearer, such as a bird dog. Optionally, puncture-resistant panels may surround the ballistic portions of the vest to provide protection from puncture or impalement, such as from sharp sticks, fence posts, barbwire, and the like. Thus, hunters and hunting dogs alike may be protected from accidental discharge of firearms commonly used for hunting small game, and may also be protected from other hazards such as impalement, without significantly reducing their comfort and range of motion.

These and other objects, advantages, purposes, and features of the present invention will become apparent upon review of the following description in conjunction with the drawings.

### BRIEF DESCRIPTION OF THE DRAWINGS

FIG. 1 is a perspective view of a ballistic garment of the present invention, adapted to fit a human wearer;

FIG. 2 is a perspective view of another ballistic garment of the present invention, positioned on a canine wearer;

FIG. 3 is a perspective view of a ballistic panel useful with the ballistic garment of FIG. 1;

FIG. 4 is a front view, of an upper portion of the ballistic panel of FIG. 3;

FIG. 5 is an enlarged front view of the ballistic panel of FIG. 3, having an outer layer partially peeled back;

FIG. 6 is an enlarged perspective view of a corner of the ballistic panel of FIG. 3, having five layers of ballistic fabric material;

FIG. 7 is a perspective view of another ballistic garment positioned on a canine wearer; and

FIG. 8 is a top plan view of the ballistic garment and canine wearer of FIG. 7.

### DESCRIPTION OF THE PREFERRED EMBODIMENTS

Referring now to the drawings and the illustrative embodiments depicted therein, a ballistic garment, one preferred form of which is referenced by the numeral 10, is provided for use by hunters or other persons involved in or near hunting activities. Another ballistic garment, one preferred form of which is referenced by the numeral 110, is provided for the protection of hunting dogs or other animals used in the vicinity of hunters. Ballistic garments 10, 110 may be in the form of a vest, a jacket, or the like in order to substantially surround and protect the vital organs of the wearer, such as the heart, lungs, kidneys, and digestive system, for example. Ballistic panels 12, 112, include a plurality of ballistic fabric sheets or layers 14 numbering fewer than is commonly used for bulletproof or bullet-resistant ballistic garments. Ballistic garments 10, 110 are thus relatively lightweight and flexible to permit freedom of movement and comfort for a human or canine wearer while providing protection against accidental discharge of firearms commonly used for hunting small game, such as shotguns loaded with bird shot or the like.

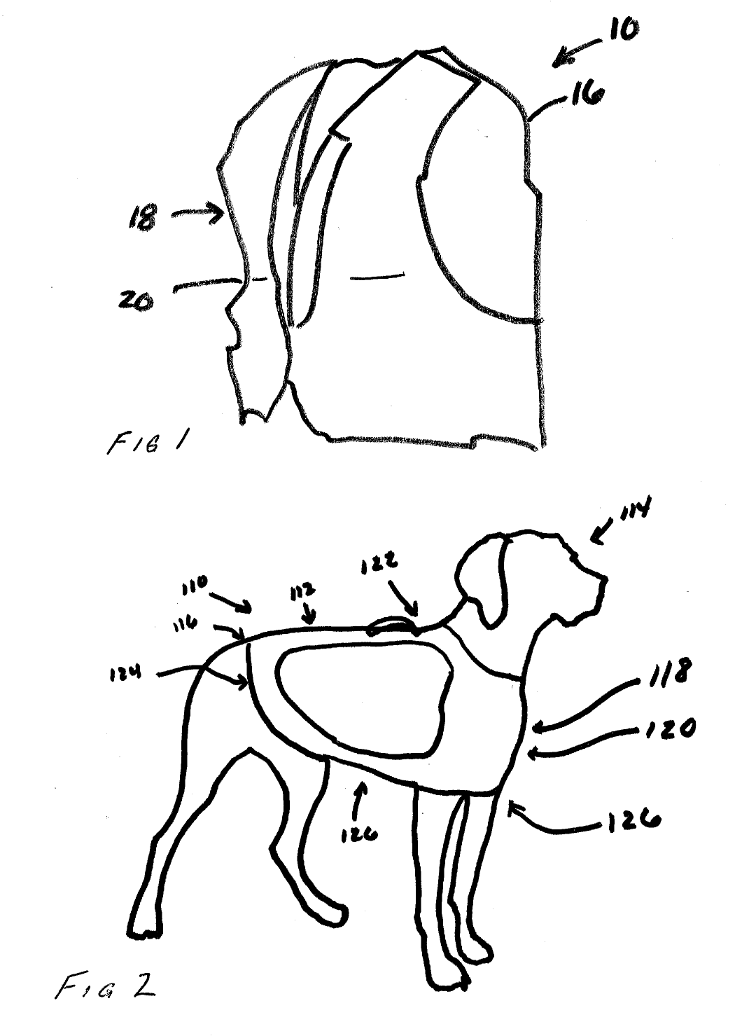

Ballistic garment 10 may be a vest 16 (FIG. 1), although other forms of clothing are envisioned, such as a sweater, a jacket, pants, or substantially any article of clothing. Vest 16 may include an outer fabric layer 18 that defines an interior region accessible via zippers 20 or other closures in order to permit insertion and removal of ballistic panels 12 from the inner regions of vest 16. Ballistic garment 10 may include, for example, four ballistic panels; one panel for protecting each of the wearer's front left, front right, back left, and back right chest regions.

Ballistic panel 12 includes a water-resistant or waterproof outer fabric layer 22 that surrounds and encloses ballistic fabric layers 14. Waterproof outer fabric layer 22 may be a rip-stop nylon fabric or similar material, and may include a waterproof or water-resistant coating thereon. Waterproof outer fabric layer 22 may include a front panel 22a and a back panel 22b, the panels being joined together along a perimeter region in order to sandwich or enclose ballistic fabric layers 14 between outer fabric layers 22a, 22b. Front panel 22a and back panel 22b may be joined or fastened together by any suitable method, such as with stitching, adhesives, or the like, and are preferably substantially sealed or seam-sealed to prevent the intrusion of water or other fluids into the region occupied by ballistic fabric layers 14.

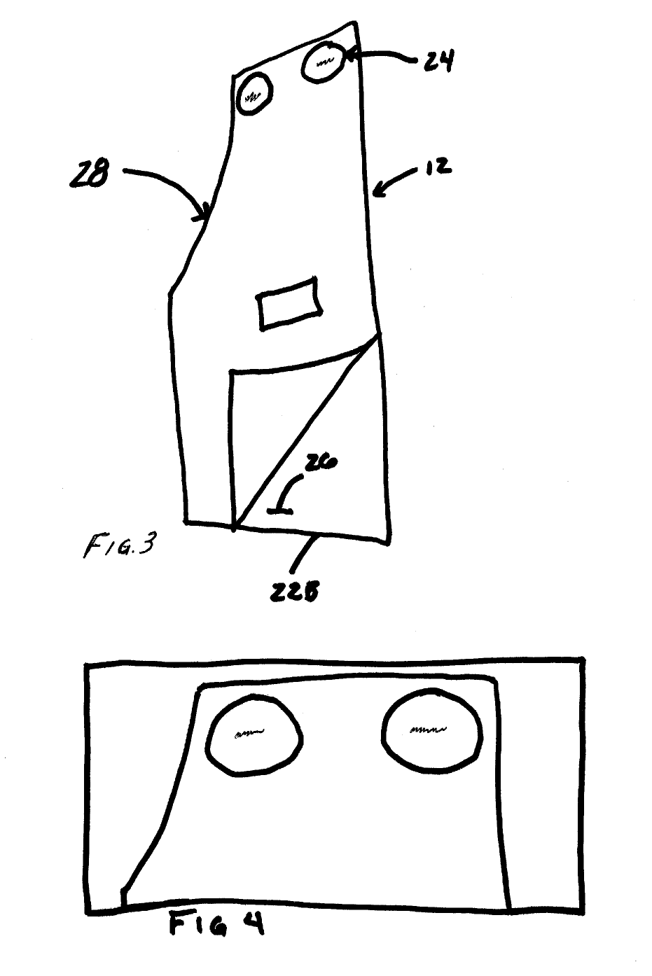

Optionally, ballistic panel 12 may include one or more fasteners, such as hook-and-loop fasteners 24 positioned at an upper portion of front panel 22a and configured to engage corresponding fasteners (not shown) at the interior region of outer fabric layer 18 of vest 16 (FIGS. 3 and 4). Fasteners 24 hold ballistic panel 12 in a relatively fixed position within vest 16 to substantially prevent damage and misalignment of the ballistic panel, while permitting the panel to be removed from the vest as desired.

Ballistic fabric layers 14 form the ballistic or pellet-resistant portion of ballistic panel 12, and preferably include between about four and eight layers of ballistic material (FIGS. 3, 5, and 6). For example, ballistic fabric layers 14 may include approximately five layers of 11×11 weave ballistic fabric. The combined weight of ballistic fabric layers 14 may preferably be between approximately 0.04 lb/ft² and approximately 0.90 lb/ft² (or more, or less), such as approximately 0.11 lb/ft² (about 1.75 oz/ft²). Ballistic fabric layers 14 may be at least partially sewn together using a bar-tac stitch 26 (FIGS. 3, 5, and 6), which aids performance of ballistic panel 12 by holding layers 14 in substantially fixed orientations relative to one another and providing for limited movement or “bounce” of layers 14 when they are struck by projectiles. Although bar-tac stitch 26 is relatively inexpensive and functional, it will be appreciated that substantially any stitch pattern may be used, or none at all, without departing from the scope of the invention.

A tape layer 28 may be applied around and along perimeter edges of ballistic fabric layers 14 in order to substantially prevent unraveling of the woven fibers that form the layers, and to facilitate assembly of ballistic panel 12 (FIG. 3). Ballistic fabric layers 14 may be made from single aramid fabric, laminated aramid fabric, high tenacity nylon, polypropylene, combinations or blends thereof, or substantially any ballistic fabric that is sufficiently flexible, lightweight, and durable.

Canine ballistic garment 110 is configured to be worn by a canine wearer, such as a hunting dog 114 (FIG. 2). Ballistic panel 112 has a perimeter region 116 with a non-ballistic fabric layer 118 sewn or otherwise fastened to a portion of perimeter region 116 of ballistic panel 112 to form a vest-like garment with front leg passageways 120, a neck passageway 122, and a torso passageway 124. Optionally, and as shown, canine ballistic garment 110 extends or tapers upwardly toward the rear of hunting dog 114 so as not to inhibit or restrict movement of the dog's hips and/or hind legs.

Canine ballistic garment 110 may include a pair of ballistic panels 112 to cover and protect respective left and right sides of hunting dog 114. Non-ballistic fabric 118 is preferably form-fitting to closely emulate the torso of hunting dog 114, and may be made of lightweight and breathable fabric, such as mesh nylon fabric that is also resistant to water, dries quickly, resists snags from burrs or other plant matter, and allows air to circulate through the fabric. Canine ballistic garment 110 may be placed on hunting dog 114 by opening the garment along a closure such as a zipper or button or hook-and-loop closure or the like at the top or back of garment 110, positioning the hunting dog's front legs through passageways 120, positioning the hunting dog's neck in passageway 122, and closing the garment with the closure aligned along the dog's spine so that ballistic panels 112 are positioned along either side of hunting dog 114.

Optionally, ballistic garments 10, 110 may comprise substantially any color or visual pattern, such as a camouflage pattern or the like. Preferably, and especially for garments for use by hunting dogs who work in the general direction of firing, it may be desirable to provide a bright color over at least a portion of the garment to increase the visibility of the wearer. For example, the garment may be “hunter orange” or “blaze orange” or some other easily-detected color to increase or maximize the visibility of the wearer.

It will be understood that ballistic panels 12, 112 are substantially resistant to penetration by shot pellets fired at any angle toward garment 10, 110. However, ballistic panels 12, 112 are generally incapable of preventing the penetration of substantially any bullet discharged from a firearm, except perhaps lighter-weight bullets fired from long ranges or bullets fired at trajectories that are nearly parallel to (but intersecting) the ballistic panels (i.e. “grazes”). Thus, when ballistic garment 10 is worn by a human wearer (or when canine ballistic garment 110 is worn by a canine wearer), the respective wearer has similar comfort and range of motion as when wearing non-ballistic garments, while being protected from substantial injury to the wearer's vital organs by accidental discharge from a firearm loaded with shot pellets commonly used for hunting small game. However, the wearer is generally not protected from injury caused by accidental discharge from a firearm loaded with substantially any type of bullet or heavy projectile.

Optionally, vests 10, 110 may include stab or puncture or impalement-resistant panels or portions 126 (FIG. 2) in place of some or all of the non-ballistic fabric layers (such as in place of non-ballistic fabric layers 118 of vest 110), particularly in the chest and belly regions that may be particularly susceptible to impalement by sharp sticks, metal or broken wooden fence posts, barbwire, and the like. Impalement-resistant panels may be made from substantially any lightweight and flexible impalement-resistant material, such as one to three layers of spike-resistant fabric, such as Kevlar® Correctional™ tightly-woven puncture-resistant fibers manufactured by E.I. du Pont de Nemours and Co. of Wilmington, Del.; Kevlar® terry cloth type fabric, or Vectran® brand liquid crystal polymer fabric, manufactured by Kuraray Co., Ltd. of Okayama, Japan.

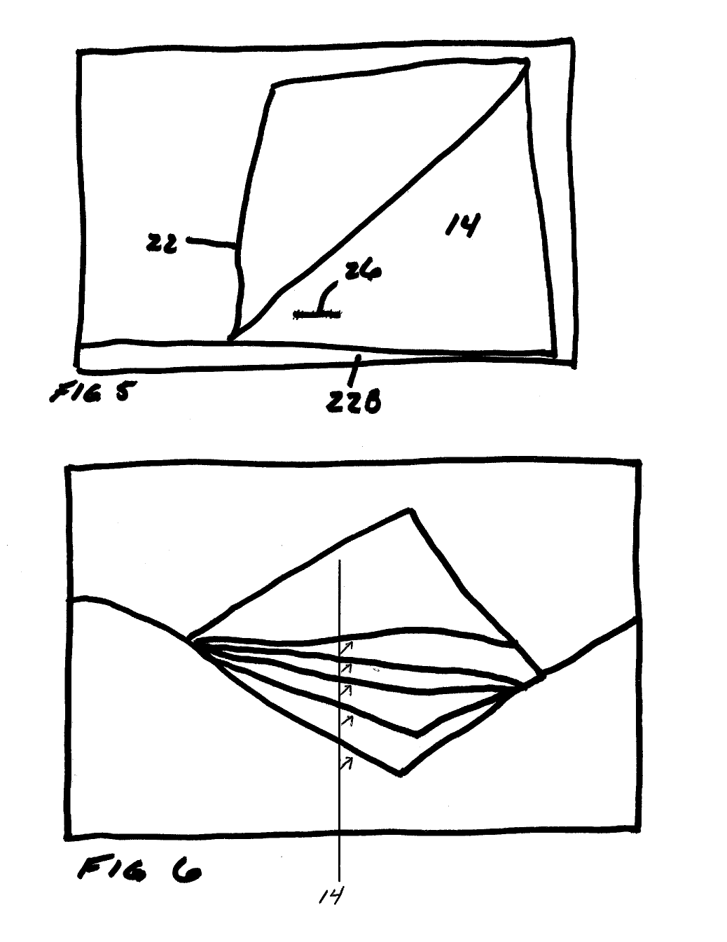

Optionally, and with reference to FIGS. 6 and 7, another canine ballistic garment 210 is substantially similar to garment 110 for use on a canine wearer 114, including a ballistic panel 212 with a perimeter region 216 with a non-ballistic fabric layer 218 sewn or otherwise fastened to a portion of perimeter region 216 of ballistic panel 212 to form a vest-like garment with front leg passageways 220, a neck passageway 222, and a torso passageway 224. Optionally, and as shown, canine ballistic garment 210 includes stab or puncture or impalement-resistant panels or portions 226 along the lower chest and/or belly regions of the garment. Impalement-resistant panels 226 may comprise a non-ballistic outer layer, such as canvas or synthetic material (such as mesh material or the like), forming a pocket or inner region for receiving approximately one to three layers of abrasion and puncture-resistant fabric forming a panel that is insertable into the non-ballistic outer layer. Panels 226 may extend further along the belly region of the dog to offer increased protection from abrasions or punctures.

In addition, canine ballistic garment 210 includes a coupling member 228, such as a loop or a D-ring or the like for receiving the end of a leash or lead 230. Coupling member 228 may be selectively covered by a hood or flap 232 that is attached (such as by sewing or riveting) at one end to garment 210, and which extends over coupling member 228. Flap 232 may include fasteners (such as snap-buttons, hook-and-loop fasteners, or the like) for releasably attaching a perimeter region of flap 232 to a portion of garment 210 near coupling member 228 to substantially cover the coupling member and prevent it from catching or snagging debris or foreign objects when the coupling member is not in use. To connect lead 230 to coupling member 228, a user first lifts an aft portion of flap 232 to expose the coupling member, which can then be used in a conventional manner. While lead 230 is coupled to coupling member 228, flap 232 may continue to at least partially cover the coupling member, as in FIG. 7.

Canine ballistic garment 210 may further be equipped with one or more handles 234 that are sewn or otherwise fastened to the garment, and which may be used for lifting or assisting the canine wearer 114, such as while climbing or descending steep slopes or entering or exiting vehicles, for example. The handles may also be covered by flaps or retained against the surface of garment 210 when not in use, to prevent them from catching or snagging on debris or foreign objects. Garment 210 may also include a zipper 236 along the spine or back of the garment and canine wearer to aid in dressing or removing the garment from the wearer. Optionally, zipper 236 is selectively covered by an elongated flap 238 along the zipper, the elongated flap being attached (such as by sewing) along one side of the zipper and including releasable fasteners (such as hook-and-loop fasteners or snap buttons) to close flap 238 over zipper 236 and to protect the zipper from debris and/or to serve as a secondary closure for the garment.

Optionally, vests 10, 110, 210 may be fitted with non-ballistic functional items or articles to provide functions other than resisting projectiles or sharp objects. For example, chilled cooling packs or inserts, or floatation packs or inserts, may be fitted inside the vests in addition to, or in place of, some or all of the ballistic panels. These non-ballistic items or articles may be sized and shaped substantially similarly to ballistic panels 12, 112, 212 for use on or in vests 10, 110, 210 and may include hook-and-loop fasteners (similar to fasteners 24) for holding the items or articles in place. Thus, the vests or articles of clothing may be given additional useful properties beyond resistance to projectiles and/or sharp objects, such as cooling the wearer or providing buoyancy while swimming, or in the event that the wearer inadvertently falls into water.

As will be appreciated by those skilled in the art, additional alternative embodiments may be envisioned in which the principles may be practiced without departing from the spirit and scope of the invention. For example, fewer than four layers of ballistic fabric material may be used if each of the layers is generally more resistant to penetration by shot pellets than the materials described herein, and greater than eight layers of ballistic fabric material may be used if each of the layers is generally less resistant to penetration by shot pellets than the materials described herein. Although generally shown and described for use in a jacket or vest for a human or canine wearer, in order to protect the vital organs of the wearer, embodiments are envisioned in which ballistic panels similar to those described herein are incorporated into pants, shorts, footwear, neckwear, headwear, or in substantially any article of clothing for which protection from shot pellets are desired.

Changes and modifications to the specifically described embodiments may be carried out without departing from the principles of the present invention, which is intended to be limited only by the scope of the appended claims, as interpreted according to the principles of patent law including the doctrine of equivalents.

1. A ballistic garment for use while hunting small game with a firearm loaded with shot pellets, said ballistic garment comprising
a flexible ballistic panel, said ballistic panel comprising a plurality of layers of ballistic fabric material having a combined weight of between about 0.04 pounds per square foot and 0.9 pounds per square foot; and
wherein said ballistic panel is adapted to substantially prevent the shot pellets from completely penetrating said ballistic panel when the shot pellets are discharged from the firearm toward said ballistic panel.

2. The ballistic garment of claim 1, wherein said plurality of layers of ballistic fabric material comprise between about four and about eight layers of ballistic fabric materials.

3. The ballistic garment of claim 2, wherein said plurality of layers of ballistic fabric material comprises about five layers of ballistic fabric materials.

4. The ballistic garment of claim 2, wherein said ballistic fabric materials comprise at least one of single aramid fabric, laminated aramid fabric, high tenacity nylon, and polypropylene.

5. The ballistic garment of claim 1, wherein said plurality of layers of ballistic fabric material have a combined weight of about 1.75 ounces per square foot.

6. The ballistic garment of claim 1, wherein said garment is adapted to fit a human wearer.

7. The ballistic garment of claim 1, wherein said garment is adapted to fit a canine wearer.

8. The ballistic garment of claim 7, wherein said ballistic panel comprises a perimeter portion, and wherein said garment comprises a non-ballistic fabric material attached to at least a portion of said ballistic panel at said perimeter portion.

9. The ballistic garment of claim 8, wherein said non-ballistic fabric material comprises a breathable mesh material.

10. The ballistic garment of claim 9, wherein said ballistic garment is form-fitting so as to closely emulate the torso of the canine wearer.

11. The ballistic garment of claim 7, wherein said ballistic panel comprises a perimeter portion, and wherein said garment comprises a stab-resistant fabric material attached to at least a portion of said ballistic panel at said perimeter portion.

12. The ballistic garment of claim 7, wherein said ballistic panel at least partially surrounds the vital organs of the canine wearer when said ballistic garment is worn by the canine wearer.

13. The ballistic garment of claim 1, wherein said ballistic panel comprises a water-resistant outer fabric layer disposed around said layers of said ballistic fabric materials.

14. The ballistic garment of claim 1, wherein said ballistic panel is substantially incapable of preventing a bullet from completely penetrating said panel when the bullet is discharged from another firearm toward said ballistic panel.

15. The ballistic garment of claim 14, wherein said garment comprises an outer fabric shell, said outer fabric shell defining an interior region, wherein said ballistic panel comprises a removable panel disposed in said interior region of said outer fabric shell.

16. The ballistic garment of claim 15, wherein said garment comprises fasteners at said outer fabric shell and at said ballistic panel, said fasteners being adapted to removably engage one another to hold said ballistic panel substantially fixed in said interior region of said outer fabric shell.

17. The ballistic garment of claim 16, wherein said fasteners comprise one of hook-and-loop fasteners, buttons, snaps, and clips.

18. A ballistic garment for use in the vicinity of a firearm loaded with shot pellets, said garment comprising:
a flexible ballistic panel, said ballistic panel comprising between about four and about eight layers of ballistic fabric materials and having a perimeter region;
a flexible non-ballistic panel, said non-ballistic panel being attached to at least a portion of said perimeter region of said flexible ballistic panel and being adapted to fit a canine wearer;
wherein said ballistic garment comprises a passageway for the canine wearer's head and separate passageways for the canine wearer's front left leg and front right leg.
wherein said ballistic panel is adapted to substantially prevent the shot pellets from completely penetrating said panel when the shot pellets are discharged from the firearm toward said panel, and wherein said ballistic panel is substantially incapable of preventing a bullet from completely penetrating said panel when the bullet is discharged from another firearm toward said panel.

19. The ballistic garment of claim 18, wherein said garment comprises a stab-resistant fabric material attached to at least a portion of said ballistic panel at said perimeter region.

20. The ballistic garment of claim 18, wherein said garment is adapted to fit a canine wearer, said garment further comprising:
a coupling member at said flexible non-ballistic panel, said coupling member adapted to receive a leash; and
a flap coupled to said flexible non-ballistic panel and releasably disposed over at least a portion of said coupling member.

21. The ballistic garment of claim 20, further comprising a handle at said flexible non-ballistic panel, said handle adapted to permit the canine wearer to be at least partially lifted by said handle.

22. A method of hunting, said method comprising:
providing a firearm loaded with at least one cartridge, the cartridge comprising a plurality of shot pellets and having a limited range of danger;
providing a ballistic garment having a flexible ballistic panel adapted to substantially prevent the shot pellets from completely penetrating said panel when the shot pellets are discharged from the firearm toward said panel, the flexible ballistic panel being substantially incapable of preventing a bullet from completely penetrating the ballistic panel when the bullet is discharged from another firearm toward the panel;
positioning the ballistic garment on a wearer; and
hunting with the firearm while the ballistic garment is within the range of danger of the firearm.

23. The method of claim 22, wherein the wearer comprises one of a human wearer and a canine wearer.
